(19) United States
(12) Patent Application Publication
(10) Pub. No.: US 2021/0356182 A1
(43) Pub. Date: Nov. 18, 2021

(54) LIQUID SUBCOOLING UTILIZING PHASE CHANGE COMPOSITE THERMAL ENERGY STORAGE AND PHASE CHANGE COMPOSITE THERMAL ENERGY STORAGE MODULE THEREFOR

(71) Applicant: NetEnergy (Naim Energy Technologies, LLC), Chicago, IL (US)

(72) Inventors: Said Al-Hallaj, Chicago, IL (US); James L. Denkmann, Chicago, IL (US)

(21) Appl. No.: 17/320,722

(22) Filed: May 14, 2021

Related U.S. Application Data
(60) Provisional application No. 63/025,985, filed on May 15, 2020.

(51) Int. Cl. F25B 39/04; F25B 6/02; F25B 41/31; F25B 41/40

(52) U.S. Cl. CPC F25B 39/04; F25B 6/02; F25B 2339/042; F25B 41/40; F25B 2400/24; F25B 41/31

(57) ABSTRACT

A cooling system comprises an air cooled condensing unit (ACCU) having a condenser outlet and a condenser inlet, and a phase change composite thermal energy storage module (PCCTESM) having first and second fluid paths disposed therethrough, wherein each of the first and second fluid paths have an inlet and an outlet. The cooling system further comprises at least one air handling unit (AHU) having an AHU inlet and an AHU outlet, a first expansion valve disposed between the condenser outlet and the first fluid path inlet, a fluid connection between the second fluid path inlet and the condenser outlet, a second expansion valve disposed between the AHU inlet and the second fluid path outlet, and a second fluid connection that connects the first fluid path outlet and the AHU outlet to the condenser inlet.

### CROSS-REFERENCE TO RELATED APPLICATIONS

This application claims the benefit of priority to U.S. Provisional Patent Application No. 63/025,985 filed on May 15, 2020 and incorporated in its entirety by reference herein.

### FIELD OF THE INVENTION

The field of this invention is in building and facilities heating and cooling systems, including the use of geothermal energy for heating and cooling.

### BACKGROUND OF THE INVENTION

Radiant cooling systems for buildings and facilities are known. Such systems chill a fluid, typically water, and circulate it through a series of pipes that are imbedded in a thermal mass, such as a concrete floor. These systems are known for their inefficiency and are known to have poor coefficients of performance. Also, because they are principled on real-time radiant heat transfer, the system must be continually operated to maintain space comfort, especially during peak temperatures extremes in a given day. Control of the circulating fluid temperature must be maintained at a temperature less than the space dewpoint temperature to preclude sweating and dripping which minimizes effectiveness of radiant cooling systems.

### SUMMARY OF THE INVENTION

In one aspect of the invention, a cooling system comprises an air cooled condensing unit (ACCU) having a condenser outlet and a condenser inlet, and a phase change composite thermal energy storage module (PCCTESM) having first and second fluid paths disposed therethrough, wherein each of the first and second fluid paths have an inlet and an outlet. The cooling system further comprises at least one air handling unit (AHU) having an AHU inlet and an AHU outlet, a first expansion valve disposed between the condenser outlet and the first fluid path inlet, a fluid connection between the second fluid path inlet and the condenser outlet, a second expansion valve disposed between the AHU inlet and the second fluid path outlet, and a second fluid connection that connects the first fluid path outlet and the AHU outlet to the condenser inlet.

In another aspect of the invention, a cooling system comprises a first air cooled condensing unit (ACCU) having a first condenser outlet and a first condenser inlet, a second air cooled condensing unit (ACCU) having a second condenser outlet and a second condenser inlet, and a phase change composite thermal energy storage module (PCCTESM) having first and second fluid paths disposed therethrough, wherein each of the first and second fluid paths have an inlet and an outlet. The cooling system further comprises at least one air handling unit (AHU) having an AHU inlet and an AHU outlet, a first fluid connection between the first condenser outlet and the second fluid path inlet, a first expansion valve disposed between the AHU inlet and the second fluid path outlet, a second expansion valve disposed between the second condenser outlet and the first fluid path inlet, a second fluid connection between the first fluid path outlet and the second condenser inlet, and a third fluid connection that connects the AHU outlet to the first condenser inlet.

In a further aspect of the invention, a phase change composite thermal energy storage module (PCCTESM) comprises a first fluid path disposed therethrough, the first fluid path having an inlet and an outlet, a second fluid path disposed therethrough, the second fluid path having an inlet and an outlet, and at least one phase change composite slab (PCCS) disposed in thermal contact with the first and second fluid paths.

### BRIEF DESCRIPTION OF THE DRAWINGS

The accompanying drawings form a part of the specification and are to be read in conjunction therewith, in which like reference numerals are employed like or similar parts in the various views and wherein:

FIG. 1 is a schematic diagram of the first embodiment of the present invention;

FIG. 2 is a schematic diagram for a control methodology for the first embodiment shown in FIG. 1;

FIG. 3 is a schematic diagram of the second embodiment of the present invention;

FIG. 4 is a schematic diagram for a control methodology for the second embodiment shown in FIG. 3;

FIG. 5 is a schematic diagram of an embodiment of a phase change composite thermal energy storage module;

FIG. 6 is a simplified version of FIG. 1 wherein minor details have been removed to show the basic structure and interconnections of the underlying components; and

FIG. 7 is a simplified version of FIG. 3 wherein minor details have been removed to show the basic structure and interconnections of the underlying components.

### DETAILED DESCRIPTION

The following detailed description of the invention references the accompanying drawing figures that illustrate the specific embodiments in which the invention can be practiced. The embodiments are intended to describe aspects of the invention in sufficient detail to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

List of Reference Numerals

| Numeral | Name |
|---|---|
| 10 | System |
| 11 | System |
| 20 | Phase Change Composite Thermal Energy |
| | Storage Module (PCCTESM) 20 |
| 12 | Space Thermostat 12 |
| 13 | Data Collection Terminal 13 |
| 14 | Central Processor Unit 14 |
| 15 | Computer 15 |
| 16 | (not used) |
| 17 | Outdoor Temperature Transmitter 17 |
| 18 | Electric Utility Meter 18 |
| 19 | Fan Coil Unit Thermostat 19 |
| 21 | Module Electronic Expansion Valve 21 |
| 22 | First Distributor 22 |
| 23 | First Distributor Tubing 23 |
| 24 | High Pressure Liquid Line 24 |
| 25 | Subcooled High Pressure Liquid Header 25 |
| 26 | Module Suction Header 26 |
| 27 | Module Thermistor 27 |
| 28 | Condenser Liquid Stop Valve 28 |
| 29 | Module Superheat Thermistor 29 |
| 30 | Module Superheat Pressure Transmitter 30 |
| 31 | Branch High Pressure Liquid Line 31 |
| 32 | Combined Suction Line 32 |
| 33 | Module Electronic Valve Controller 33 |
| 34 | Suction Line Inlet to Suction Trap 34 |
| 35 | Suction Line Stop Valve 35 |
| 36 | Suction Trap 36 |
| 37 | Condenser Variable Frequency Drive 37 |
| 38 | Compressor Inlet Suction Line 38 |
| 39 | Variable Frequency Compressor 39 |
| 40 | Hot Gas Line 40 |
| 41 | Air Cooled Condenser 41 |
| 42 | Condenser Fan Motor 42 |
| 43 | Condenser Fan 43 |
| 44 | Air Cooled Condensing Unit 44 |
| 45 | Air Handling Unit Suction Line 45 |
| 46 | Fan Coil Unit 46 |
| 47 | Fan Coil Unit Evaporator 47 |
| 48 | Electronic Expansion Valve Controller 48 |
| 49 | Fan Coil Unit Suction Line 49 |
| 50 | Space Air Handling Unit 50 |
| 51 | Air Handling Unit Evaporator 51 |
| 52 | Air Handling Unit Filter Bank 52 |
| 53 | Air Handling Unit Fan 53 |
| 54 | Belt Drive 54 |
| 55 | Air Handling Unit Fan Motor 55 |
| 56 | Air Handling Unit Electronic Expansion Valve 56 |
| 57 | Air Handling Unit Electronic Expansion Valve Distributor 57 |
| 58 | Air Handling Unit Electronic Expansion Valve Distributor |
| | Tubing 58 |
| 59 | Air Handling Unit Expansion Valve Superheat Thermistor 59 |
| 60 | Air Handling Unit Expansion Valve Superheat Pressure |
| | Transmitter 60 |
| 61 | Subcooled High Pressure Liquid Line 61 |
| 62 | Air Handling Unit Variable Frequency Drive 62 |
| 63 | Air Handling Unit Expansion Valve Controller 63 |
| 64 | Tee 64 |
| 65 | Module Saturated High Pressure Liquid Header 65 |
| 66 | Electronic Expansion Valve 66 |
| 67 | Tee 67 |
| 68 | Tee 68 |
| 69-73 | (not used) |
| 74 | Air Handling Unit 74 |
| 75 | Evaporator 75 |
| 76 | Filter Bank 76 |
| 77 | Expansion Valve Controller 77 |
| 78 | Electronic Expansion Valve 78 |
| 79 | Distributor 79 |
| 80 | Distributor Tubing 80 |
| 81 | Subcooled High Pressure Liquid Line 81 |
| 82 | Air Handling Unit Expansion Valve Superheat Thermistor 82 |
| 83 | Suction Line 83 |
| 84 | Air Handling Unit Expansion Valve Superheat Pressure |
| | Transmitter 84 |
| 85 | Variable Frequency Drive 85 |
| 86 | Air Handling Unit Fan 86 |
| 87 | Belt Drive 87 |
| 88 | Variable Frequency Drive 88 |
| 89 | Module Thermistor 89 |
| 90 | Subcooled High Pressure Liquid Header 90 |
| 91 | Module Suction Header 91 |
| 92 | Supplemental Condenser Fan 92 |
| 93 | Supplemental Air Cooled Condensing Unit 93 |
| 94 | Supplemental Condenser Fan Motor 94 |
| 95 | Supplemental Condensing Unit Hot Gas Line 95 |
| 96 | Supplemental Variable Speed Compressor 96 |
| 97 | Supplemental Air Cooled Condenser 97 |
| 98 | Supplemental High Pressure Liquid Stop Valve 98 |
| 99 | Supplemental High Pressure Liquid Line 99 |
| 100 | Module Superheat Thermistor 100 |
| 101 | Module Superheat Pressure Transmitter 101 |
| 102 | Supplemental Condensing Unit Suction Trap 102 |
| 103 | Supplemental Condensing Unit Suction Line Stop Valve 103 |
| 104 | Supplemental Condensing Unit Suction Line 104 |
| 105 | Module Electronic Expansion Valve 105 |
| 106 | Module Electronic Expansion Valve Distributor 106 |
| 107 | Module Electronic Expansion Valve Distributor Tubing 107 |
| 108 | Module Saturated High Pressure Liquid Header 108 |
| 109 | Module Electronic Valve Controller 109 |
| 110 | Variable Frequency Drive 110 |
| 111 | Air Cooled Condensing Unit 111 |
| 112 | Condenser Fan 112 |
| 113 | Condenser Fan Motor 113 |
| 114 | Air Cooled Condenser 114 |
| 115 | Condensing Unit Hot Gas Line 115 |
| 116 | Compressor Suction Line 116 |
| 117 | High Pressure Liquid Stop Valve 117 |
| 118 | Suction Line Inlet To Suction Trap 118 |
| 119 | Suction Line Stop Valve 119 |
| 120 | Liquid To Suction Heat Exchanger 120 |
| 121 | Suction Trap 121 |
| 122 | Variable Speed Compressor 122 |
| 123 | Saturated High Pressure Liquid Line 123 |
| 124 | Subcooled High Pressure Liquid Line 124 |
| 125 | Compressor Suction Line 125 |
| 126 | Suction Trap Entering Line 126 |
| 127-200 | (not used) |
| 201 | Upper Insulation 201 |
| 202 | Lower Insulation 202 |
| 203-220 | (not used) |
| 221 | First Change Composite Slab 221 |
| 222 | Second Phase Change Composite Slab 222 |
| 223 | Third Phase Change Composite Slab 223 |
| 224 | Fourth Phase Change Composite Slab 224 |
| 225 | Fifth Phase Change Composite Slab 225 |
| 226 | Sixth Phase Change Composite Slab 226 |
| 227 | Seventh Phase Change Composite Slab 227 |
| 228 | Eighth Phase Change Composite Slab 228 |
| 229 | Ninth Phase Change Composite Slab 229 |
| 230 | Superheated Suction Vapor 230 |
| 231 | First Cold Aluminum Micro Channel Heat Exchanger 231 |
| 232 | First Warm Aluminum Micro Channel Heat Exchanger 232 |
| 233 | Second Cold Aluminum Micro Channel Heat Exchanger 233 |
| 234 | Second Warm Aluminum Micro Channel Heat Exchanger 234 |
| 235 | Third Cold Aluminum Micro Channel Heat Exchanger 235 |
| 236 | Third Warm Aluminum Micro Channel Heat Exchanger 236 |
| 237 | Fourth Cold Aluminum Micro Channel Heat Exchanger 237 |
| 238 | Fourth Warm Aluminum Micro Channel Heat Exchanger 238 |
| 239 | Fifth Cold Aluminum Micro Channel Heat Exchanger 239 |
| 240-249 | (not used) |
| 250 | First Cold Aluminum Micro Channel Heat Exchanger Inlet |
| | Header 250 |
| 251 | First Cold Aluminum Heat Exchanger Outlet Header 251 |
| 252 | First Warm Aluminum Micro Channel Heat Exchanger Inlet |
| | Header 252 |
| 253 | First Warm Aluminum Micro Channel Heat Exchanger |
| | Outlet Header 253 |
| 254 | Second Cold Aluminum Micro Channel Heat Exchanger |
| | Inlet Header 254 |
| 255 | Second Cold Aluminum Micro Channel Heat Exchanger |
| | Outlet Header 255 |
| 256 | Second Warm Aluminum Micro Channel Heat Exchanger |
| | Inlet Header 256 |
| 257 | Second Warm Aluminum Micro Channel Heat Exchanger |
| | Outlet Header 257 |
| 258 | Third Cold Aluminum Micro Channel Heat Exchanger |
| | Inlet Header 258 |
| 259 | Third Cold Aluminum Micro Channel Heat Exchanger |
| | Outlet Header 259 |
| 260 | Third Warm Aluminum Micro Channel Heat Exchanger |
| | Inlet Header 260 |
| 261 | Third Warm Aluminum Micro Channel Heat Exchanger |
| | Outlet Header 261 |
| 262 | Fourth Cold Aluminum Micro Channel Heat Exchanger |
| | Inlet Header 262 |
| 263 | Fourth Cold Aluminum Micro Channel Heat Exchanger |
| | Outlet Header 263 |
| 264 | Fourth Warm Aluminum Micro Channel Heat Exchanger |
| | Inlet Header 264 |
| 265 | Fourth Warm Aluminum Micro Channel Heat Exchanger |
| | Outlet Header 265 |
| 266 | Fifth Cold Aluminum Micro Channel Heat Exchanger |
| | Inlet Header 266 |
| 267 | Fifth Cold Aluminum Micro Channel Heat Exchanger |
| | Outlet Header 267 |

It should be noted that researchers have explored and reported in the literature extensive studies on the subject of “using Phase Change Material for Thermal Energy Storage with Air Conditioning applications” (hereinafter referred to by the acronym PCMTESAC). The previously proposed PCMTESAC solutions included various methods to best integrate the different technologies of thermal energy storage and air conditioning. However, all such previous attempts had serious shortcomings that rendered the proposed solutions impractical or cost ineffective. For example, a basic problem was that phase change composite slabs tend to be leaky and difficult to seal, especially when coolant or heat exchanger tubing is run through them, which results in the phase change wax leaking out. Another known problem with the integration of phase change material into a large air conditioning system is that the rate of heat transfer from the phase change material was insufficient to keep up with demand during peak times.

That all prior attempts to create a practical and cost-effective PCMTESAC failed is not an entirely unexpected result because major breakthroughs in interdisciplinary fields across multiple technologies typically require knowledge and experience across the technologies. For example, PCMTESAC requires in-depth knowledge of the fundamental science, engineering, and applications of air conditioning, which are typically possessed by experienced mechanical engineers, and in addition PCMTESAC requires in-depth knowledge of material science, heat transfer, and material processing techniques, and experience with phase change material, which are typically possessed by chemical engineers or material scientists.

In order to overcome the shortcomings above and develop an innovative and superior technical PCMTESAC solution requires a previously unknown combination of elements, some of which are unknown, to produce the new and improved result. Such a solution as disclosed herein integrates thermal energy storage and air conditioning apparatus in a cost-efficient manner via a combination of material selection for the phase change material slab and construction of the Phase Change Composite Thermal Energy Storage Module (hereinafter “PCCTESM”) 20 that is integrated into air conditioning system design, operation, and control in a new way. The disclosed structure of the PCCTESM 20 provides a novel structure that solves the leakage problem, for example, by separating slabs of phase change composite material into separate fluidly sealed modules that can be stacked in thermal contact with heat exchangers that can be run through the PCCTESM 20 to heat and/or cool the phase change material as needed. Furthermore, the combination of elements disclosed herein provides an entirely new architecture for structurally and operationally integrating the PCCTESM 20 into a large scale air conditioning system. The combination of elements disclosed herein is therefore not just a simple addition or combination of previously known technologies, but rather has a performance and energy efficiency far beyond any ordinary combination of known elements combined in their normal way to produce a known result. For example, the new architecture provides for simultaneous space cooling and liquid subcooling through the phase change module using either one or two air cooled condensing units.

To those schooled in the art of air conditioning systems, those persons will be aware of the benefits of subcooling a high pressure liquid stream. Two systems are described herein, the first utilizing a single air cooled condensing unit and the second utilizing dual air cooled condensing units. As one might be aware, there is an initial cost associated with utilizing dual condensing units, however in many cases this initial cost can be offset by both electrical energy and demand savings, especially during times of high ambient temperature extremes. Use of dual air cooled condensing units affords the user to utilize the energy cost advantages of employing dual evaporating temperatures to provide simultaneous space cooling and liquid subcooling. Furthermore, the use of dual air cooled condensing units permits dual variable compressor operation in accordance with local utility electrical demand rates.

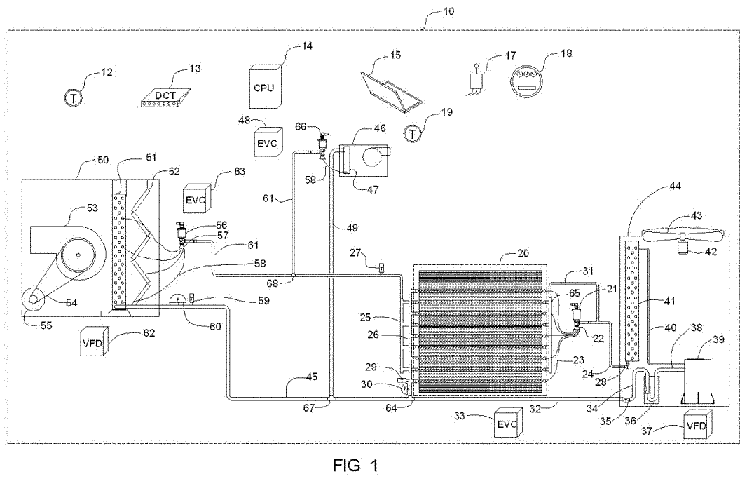

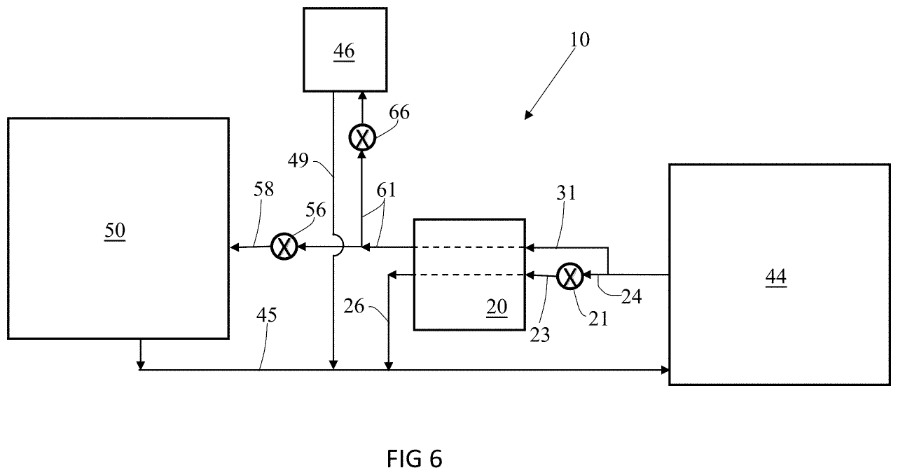

FIGS. 1 and 6 depict schematic diagrams of a first embodiment of a System 10 wherein a single Air Cooled Condensing Unit (hereinafter “ACCU”) 44 is utilized to provide cooling to a space while simultaneously removing heat from a PCCTESM 20. FIG. 6 is a simplified version of FIG. 1 wherein minor details have been removed to show the basic structure and interconnections of the underlying components.

Referring to FIGS. 1 and 6, warm high pressure liquid phase refrigerant exits the ACCU 44 through Condenser Liquid Stop Valve 28 and enters High Pressure Liquid Line 24. From here, the high pressure liquid refrigerant is directed along at least one of two fluid paths through the PCCTESM 20. In a first fluid path, high pressure liquid refrigerant flows through a Module Electronic Expansion Valve 21 and a First Distributor 22 into First Distributor Tubing 23, and then into the PCCTESM 20.

In a second path, high pressure liquid refrigerant flows from High Pressure Liquid Line 24 into Branch High Pressure Liquid Line 31 where it then flows into Module Saturated High Pressure Liquid Header 65 to be subcooled within the PCCTESM 20.

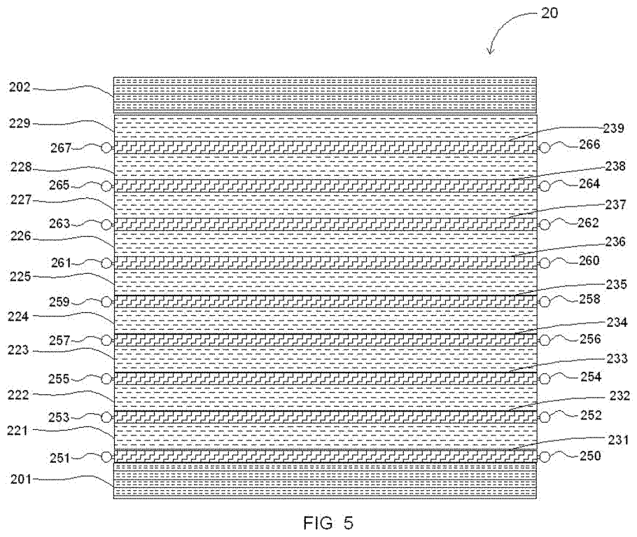

Now turning to FIG. 5, an embodiment of the parts comprising the PCCTESM 20 are illustrated. Aluminum Micro Channel Heat Exchangers 231 through 239 inclusive are shown sandwiched between layers of Phase Change Composite Slabs 221 through 229 inclusive. As an alternate embodiment to this numerical arrangement, the PCCTESM 20, may be comprised of additional or fewer Phase Change Composite Slabs 221-229 and Aluminum Micro Channel Heat Exchangers 231-239 other than those shown in FIG. 5. Further, while these components have been shown in a horizontal configuration in the embodiment illustrated in FIG. 5, they can be vertically arranged in an alternate embodiment.

Additionally, in describing the flow of refrigerant through the PCCTESM 20 shown in FIG. 5, the primary description provided below is in the context of a co-flowing type of heat exchanger where relatively warmer and cooler streams enter the PCCTESM 20 from the same side, flow in the same direction through the PCCTESM 20, and exit from the same side. The diagram of the PCCTESM 20 shown in FIG. 5 is consistent with this co-flowing context. However, in another embodiment, the PCCTESM 20 is configured in the context of a counter-flow heat exchanger where the relatively warmer and cooler streams enter the PCCTESM 20 from opposite sides and flow counter to one another exiting on opposite sides. The counter-flow context and differences in the PCCTESM 20 required for achieving the counter-flow context will be noted below where appropriate.

In an embodiment, Phase Change Composite Slabs 221-229 are comprised of a thermally conductive graphite matrix with a low temperature phase change wax impregnated within the graphite matrix. The wax changes phase between liquid and solid. In an embodiment, the phase change temperature of said wax ranges between about 2° C. and about 4° C. The graphite matrix slab, while having a thermally conductive surface is fluidly sealed to prevent liquid phase wax from leaking out.

Along the first path, starting at the lower most portion of the PCCTESM 20, a first cold Aluminum Micro Channel Heat Exchanger 231 receives a cold liquid and vapor refrigerant stream exiting from the Module Electronic Expansion Valve 21 shown in FIG. 1 via a first Cold Aluminum Micro Channel Heat Exchanger Inlet Header 250. The first cold Aluminum Micro Channel Heat Exchanger 231 is in thermal contact with a first Phase Change Composite Slab 221. Heat is then free to flow from the first Phase Change Composite Slab 221 into the first Cold Aluminum Micro Channel Heat Exchanger 231. This heat flow can cause all remaining liquid in the first Cold Aluminum Micro Channel Heat Exchanger 231 to boil away. The resulting refrigerant vapor stream then exits via a first Cold Aluminum Heat Exchanger Outlet Header 251.

Along the second path, a warm high pressure liquid stream enters a first Warm Aluminum Micro Channel Heat Exchanger 232 via a first Warm Aluminum Micro Channel Heat Exchanger Inlet Header 252. The first Warm Aluminum Micro Channel Heat Exchanger 232 is in thermal contact with the first Phase Change Composite Slab 221. Heat flows into the first Phase Change Composite Slab 221 from the first Warm Aluminum Micro Channel Heat Exchanger 232, subcooling the high pressure liquid stream as it flows through the First Warm Aluminum Micro Channel Heat Exchanger 232. The now subcooled high pressure liquid stream exits the First Warm Aluminum Micro Channel Heat Exchanger 232 via a First Warm Aluminum Micro Channel Heat Exchanger Outlet Header 253. FIG. 5 illustrates the positions of the first Warm Aluminum Micro Channel Heat Exchanger Inlet and Outlet Headers 252, 253 in a co-flowing context wherein the flow is right to left across the PCCTESM 20; however, in a counterflow version of the PCCTESM 20, the Headers 252, 253 would be on reversed sides so that the flow is left to right across the PCCTESM 20.

In an embodiment, Aluminum Micro Channel Heat Exchangers 231-239 are stacked so that a first set of every other heat exchangers receives cold boiling refrigerant and a second set of every other heat exchangers receives warm high pressure liquid to be subcooled. For example, in an embodiment, referring to FIG. 5, additional Phase Change Composite Slabs 222-229 or more can be stacked in thermal contact atop the structure described hereinabove with alternating cold and hot Aluminum Micro Channel Heat Exchangers 231-239, or more, disposed therebetween. For example, atop the First Warm Aluminum Micro Channel Heat Exchanger 232 is disposed in thermal contact another phase change composite slab, for example a second Phase Change Composite Slab 222. Heat flows into the second Phase Change Composite Slab 222 from the first Warm Aluminum Micro Channel Heat Exchanger 232, subcooling the high pressure liquid stream as it flows through the First Warm Aluminum Micro Channel Heat Exchanger 232.

Continuing the arrangement of components in thermal contact upwardly as shown in FIG. 5, above the second Phase Change Composite Slab 222 is disposed in thermal contact a Second Cold Aluminum Micro Channel Heat Exchanger 233. Heat is free to flow from the second Phase Change Composite Slab 222 into the second Cold Aluminum Micro Channel Heat Exchanger 233. This heat flow can cause all remaining liquid in the second Cold Aluminum Micro Channel Heat Exchanger 233 to boil away.

Continuing, in an embodiment, above the second Cold Aluminum Micro Channel Heat Exchanger 233 is disposed in thermal contact a third Phase Change Composite Slab 223. Heat is free to flow from the third Phase Change Composite Slab 223 into the second Cold Aluminum Micro Channel Heat Exchanger 233. This heat flow can cause all remaining liquid in the second Cold Aluminum Micro Channel Heat Exchanger 233 to boil away.

In an embodiment, above the third Phase Change Composite Slab 223 is disposed in thermal contact a second Warm Aluminum Micro Channel Heat Exchanger 234. Heat flows into the third Phase Change Composite Slab 223 from the second Warm Aluminum Micro Channel Heat Exchanger 234, subcooling the high pressure liquid stream as it flows through the second Warm Aluminum Micro Channel Heat Exchanger 234. FIG. 5 illustrates the positions of second Warm Aluminum Micro Channel Heat Exchanger Inlet and Outlet Headers 256, 257 in a co-flowing context wherein the flow is right to left across the PCCTESM 20; however, in a counterflow version of the PCCTESM 20, the Headers 256, 257 would be on reversed sides so that the flow is left to right across the PCCTESM 20.

In an embodiment, above the second Warm Aluminum Micro Channel Heat Exchanger 234 is disposed in thermal contact a fourth Phase Change Composite Slab 224. Heat flows into the fourth Phase Change Composite Slab 224 from the second Warm Aluminum Micro Channel Heat Exchanger 234, subcooling the high pressure liquid stream as it flows through the second Warm Aluminum Micro Channel Heat Exchanger 234.

In an embodiment, above the fourth Phase Change Composite Slab 224 is disposed in thermal contact a third Cold Aluminum Micro Channel Heat Exchanger 235. Heat is free to flow from the fourth Phase Change Composite Slab 224 into the third Cold Aluminum Micro Channel Heat Exchanger 235. This heat flow can cause all remaining liquid in the third Cold Aluminum Micro Channel Heat Exchanger 235 to boil away.

In an embodiment, as illustrated in FIG. 5, above the third Cold Aluminum Micro Channel Heat Exchanger 235 is disposed in thermal contact a fifth Phase Change Composite Slab 225. Heat is free to flow from the fifth Phase Change Composite Slab 225 into the third Cold Aluminum Micro Channel Heat Exchanger 235. This heat flow can cause all remaining liquid in the third Cold Aluminum Micro Channel Heat Exchanger 235 to boil away.

In an embodiment, above the fifth Phase Change Composite Slab 225 is disposed in thermal contact a third Warm Aluminum Micro Channel Heat Exchanger 236. Heat flows into the fifth Phase Change Composite Slab 225 from the third Warm Aluminum Micro Channel Heat Exchanger 236, subcooling the high pressure liquid stream as it flows through the third Warm Aluminum Micro Channel Heat Exchanger 236. FIG. 5 illustrates the positions of third Warm Aluminum Micro Channel Heat Exchanger Inlet and Outlet Headers 260, 261 in a co-flowing context wherein the flow is right to left across the PCCTESM 20; however, in a counterflow version of the PCCTESM 20, the Headers 260, 261 would be on reversed sides so that the flow is left to right across the PCCTESM 20.

In an embodiment, above the third Warm Aluminum Micro Channel Heat Exchanger 236 is disposed in thermal contact a sixth Phase Change Composite Slab 226. Heat flows into the sixth Phase Change Composite Slab 226 from the third Warm Aluminum Micro Channel Heat Exchanger 236, subcooling the high pressure liquid stream as it flows through the third Warm Aluminum Micro Channel Heat Exchanger 236.

In an embodiment, above the sixth Phase Change Composite Slab 226 is disposed in thermal contact a fourth Cold Aluminum Micro Channel Heat Exchanger 237. Heat is free to flow from the sixth Phase Change Composite Slab 226 into the fourth Cold Aluminum Micro Channel Heat Exchanger 237. This heat flow can cause all remaining liquid in the fourth Cold Aluminum Micro Channel Heat Exchanger 237 to boil away.

In an embodiment, as illustrated in FIG. 5, above the fourth Cold Aluminum Micro Channel Heat Exchanger 237 is disposed in thermal contact a seventh Phase Change Composite Slab 227. Heat is free to flow from the seventh Phase Change Composite Slab 227 into the fourth Cold Aluminum Micro Channel Heat Exchanger 237. This heat flow can cause all remaining liquid in the fourth Cold Aluminum Micro Channel Heat Exchanger 237 to boil away.

In an embodiment, above the seventh Phase Change Composite Slab 227 is disposed in thermal contact a fourth Warm Aluminum Micro Channel Heat Exchanger 238. Heat flows into the seventh Phase Change Composite Slab 227 from the fourth Warm Aluminum Micro Channel Heat Exchanger 238, subcooling the high pressure liquid stream as it flows through the fourth Warm Aluminum Micro Channel Heat Exchanger 238. FIG. 5 illustrates the positions of fourth Warm Aluminum Micro Channel Heat Exchanger Inlet and Outlet Headers 264, 265 in a co-flowing context wherein the flow is right to left across the PCCTESM 20; however, in a counterflow version of the PCCTESM 20, the Headers 264, 265 would be on reversed sides so that the flow is left to right across the PCCTESM 20.

In an embodiment, above the fourth Warm Aluminum Micro Channel Heat Exchanger 238 is disposed in thermal contact an eighth Phase Change Composite Slab 228. Heat flows into the eighth Phase Change Composite Slab 228 from the fourth Warm Aluminum Micro Channel Heat Exchanger 238, subcooling the high pressure liquid stream as it flows through the third Warm Aluminum Micro Channel Heat Exchanger 238.

In an embodiment, above the eighth Phase Change Composite Slab 228 is disposed in thermal contact a fifth Cold Aluminum Micro Channel Heat Exchanger 239. Heat is free to flow from the eighth Phase Change Composite Slab 228 into the fifth Cold Aluminum Micro Channel Heat Exchanger 239. This heat flow can cause all remaining liquid in the fifth Cold Aluminum Micro Channel Heat Exchanger 239 to boil away.

In an embodiment, as illustrated in FIG. 5, above the fifth Cold Aluminum Micro Channel Heat Exchanger 239 is disposed in thermal contact a ninth Phase Change Composite Slab 229. Heat is free to flow from the ninth Phase Change Composite Slab 229 into the fifth Cold Aluminum Micro Channel Heat Exchanger 239. This heat flow can cause all remaining liquid in the fifth Cold Aluminum Micro Channel Heat Exchanger 239 to boil away.

Continuing the pattern, in an embodiment additional layers of a Phase Change Composite Slab can be stacked in thermal contact between alternating Warm and Cold Aluminum Micro Channel Heat Exchangers as described hereinabove. Heat flows between the additional layers in like fashion as described hereinabove for the Phase Change Composite Slabs 221-229.

In an embodiment, a plurality of first heat exchangers, for example, the first through fifth cold Aluminum Micro Channel Heat Exchangers 231, 233, 235, 237, and 239 are in fluid communication with a first common inlet source and a first common outlet header. For example, in an embodiment, each of the first through fifth cold Aluminum Micro Channel Heat Exchangers 231, 233, 235, 237, and 239 is supplied by a first through fifth Cold Aluminum Micro Channel Heat Exchanger Inlet Header 250, 254, 258, 262, and 266, respectively, which are all in fluid communication with and commonly supplied by the first common inlet source comprising the First Distributor 22 via the First Distributor Tubing 23. A refrigerant vapor stream exits from each of the first through fifth cold Aluminum Micro Channel Heat Exchangers 231, 233, 235, 237, and 239 via a first through fifth Cold Aluminum Micro Channel Heat Exchanger Outlet Header 251, 255, 259, 263, and 267, respectively, which are all in fluid communication with the first common outlet header comprising a Subcooled High Pressure Liquid Header 25.

Similarly, in an embodiment, a plurality of second heat exchangers, for example, the first through fourth Warm Aluminum Micro Channel Heat Exchangers 232, 234, 236, and 238 are in fluid communication with a second common inlet source and a second common outlet header. For example, in an embodiment, a warm high pressure liquid stream enters each of the first through fourth Warm Aluminum Micro Channel Heat Exchangers 232, 234, 236, and 238 via first through fourth Warm Aluminum Micro Channel Heat Exchanger Inlet Headers 252, 256, 260, and 264, respectively, which are all in fluid communication with and commonly supplied by the second common inlet source comprising the Module Saturated High Pressure Liquid Header 65. A subcooled high pressure liquid stream exits each of the first through fourth Warm Aluminum Micro Channel Heat Exchangers 232, 234, 236, and 238 via a first through fourth Warm Aluminum Micro Channel Heat Exchanger Outlet Header 253, 257, 261, and 265, respectively, which are all in fluid communication with the second common outlet header comprising a Module Suction Header 26. In an embodiment, as shown in FIG. 5, atop the topmost component of the PCCTESM 20 is disposed a layer of insulation 202 and under the bottommost component of the PCCTESM 20 is disposed another layer of insulation 201.

Consistent with the description above regarding co-flowing and counter-flowing refrigerant streams, in the co-flowing context of the PCCTESM 20, the first and second common inlet sources are disposed on a same side of the PCCTESM 20 and the first and second common outlet headers are disposed on a same side of the PCCTESM 20. However, in the counter-flowing context of the PCCTESM 20, the first and second common inlet sources are disposed on opposite sides of the PCCTESM 20 and the first and second common outlet headers are disposed on opposite sides of the PCCTESM 20.

In addition, in another embodiment, one or more of the plurality of first heat exchangers can be reversed to flow in an opposite direction than the others of the plurality of first heat exchangers. Similarly, one or more of the plurality of second heat exchangers can be reversed to flow in an opposite direction than the others of the plurality of second heat exchangers. By reversing one or more of the first and/or second pluralities of heat exchangers relative to the others of the first and second pluralities of heat exchangers, the configuration of the PCCTESM can be a combination of co-flowing and counter-flowing refrigerant streams. In such a PCCTESM 20 having a combination co-flowing and counter-flowing refrigerant streams, the plurality of first heat exchangers are in fluid communication with a first common inlet source and a first common outlet header. Similarly, in such a PCCTESM 20 having a combination co-flowing and counter-flowing refrigerant streams, the plurality of second heat exchangers are in fluid communication with a second common inlet source and a second common outlet header.

The first through fifth Cold Aluminum Micro Channel Heat Exchanger Inlet Headers 250, 254, 258, 262, and 266 receive a mixture of cold boiling liquid and vapor from Module Electronic Expansion Valve 21 shown in FIGS. 1 and 6. The first through fourth Warm Aluminum Micro Channel Heat Exchanger Inlet Headers 252, 256, 260, and 264 may receive warm high pressure liquid to be subcooled within the PCCTESM 20. The first through fifth Cold Aluminum Micro Channel Heat Exchanger Outlet Headers 251, 255, 259, 263, and 267 may convey cold refrigerant vapor having a few degrees of superheat. The first through fourth Warm Aluminum Micro Channel Heat Exchanger Outlet Headers 253, 257, 261, and 265 may convey streams of subcooled high pressure liquid.

While a singular PCCTESM 20 has been described herein, multiples of same maybe employed in any given system. These may be interconnected in series or in parallel.

Now returning to FIG. 1 (and FIG. 6), in an embodiment, cold, slightly superheated vapor exits the PCCTESM 20 and enters the Module Suction Header 26. In an embodiment a Module Superheat Thermistor 29 and a Module Superheat Pressure Transmitter 30 sense superheat and may be interconnected to a Module Electronic Valve Controller 33. In an embodiment subcooled high pressure liquid exits the PCCTESM 20 and enters a Subcooled High Pressure Liquid Header 25. Subcooled high pressure liquid exits the Subcooled High Pressure Liquid Header 25 and enters a Subcooled High Pressure Liquid Line 61.

In an embodiment a Module Thermistor 27 may sense subcooled high pressure liquid temperature and, through software regulate a Variable Frequency Compressor 39 speed inside the ACCU 44 to maintain a desired controlled temperature. In an embodiment subcooled high pressure liquid flows down the Subcooled High Pressure Liquid Line 61 to a Tee 68. In an embodiment a branch line Subcooled High Pressure Liquid Line 61 connects to an Electronic Expansion Valve 66 where it flashes down to a lower pressure which may feed a mixture of cold refrigerant liquid and vapor through an Air Handling Unit Electronic Expansion Valve Distributor Tubing 58 to a Fan Coil Unit Evaporator 47 inside a Fan Coil Unit 46. In an embodiment the Fan Coil Unit 46 may be singular or there may be multiples of same to provide comfort air conditioning to a building or facility.

In an embodiment a Thermostat 19 may control a zone temperature conditioned by the Fan Coil Unit 46. From the run of Tee 68, in an embodiment subcooled high pressure liquid continues to flow through Subcooled High Pressure Liquid Line 61 to an Air Handling Unit Electronic Expansion Valve 56 where it flashes down to a lower pressure which then feeds a mixture of cold liquid and vapor through an Air Handling Unit Electronic Expansion Valve Distributor 57 and into the Air Handling Unit Electronic Expansion Valve Distributor Tubing 58 which in an embodiment then may feed this mixture to an Air Handling Unit Evaporator 51 inside a Space Air Handling Unit 50. In an embodiment air Handling Unit Fan 53 draws air from a conditioned space through an Air Handling Unit Filter Bank 52 and into Air Handling Unit Evaporator 51. Air is cooled by the boiling and evaporating process inside Air Handling Unit Evaporator 51 which converts cold liquid into cold vapor.

In an embodiment said slightly superheated cold vapor exits the Air Handling Unit Evaporator 51 and enters an Air Handling Unit Suction Line 45. In an embodiment an Air Handling Unit Expansion Valve Superheat Thermistor 59 and an Air Handling Unit Expansion Valve Superheat Pressure Transmitter 60, through their interconnection to an Air Handling Unit Expansion Valve Controller 63 regulate the degrees of superheat within the Air Handling Unit Evaporator 51. In an embodiment this slightly superheated vapor may then flow through the Air Handling Unit Suction Line 45 to a Tee 67 where it may combine with vapor returning from the Fan Coil Unit Evaporator 47 inside the Fan Coil Unit 46. In an embodiment this vapor may then flow to a Tee 64 where it may combine with vapor returning from the PCCTESM 20. In an embodiment this combined suction vapor may then flow through a Combined Suction Line 32 to a Suction Line Stop Valve 35 inside the ACCU 44. After exiting the Suction Line Stop Valve 35, in an embodiment, vapor may enter a Suction Trap 36 after passing through a Suction Inlet Line 34 to the Suction Trap 36. In an embodiment vapor then may enter a Compressor Inlet Suction Line 38, then may enter the Variable Frequency Compressor 39. The purpose of the Suction Trap 36 is to catch any liquid that may exit any connected evaporator in order to protect the Variable Frequency Compressor 39. Those schooled in refrigeration techniques will be familiar with the deleterious effects of liquid upon a scroll compressor in that said liquid tends to dilute lubricating oils which is harmful to bearings within said compressor.

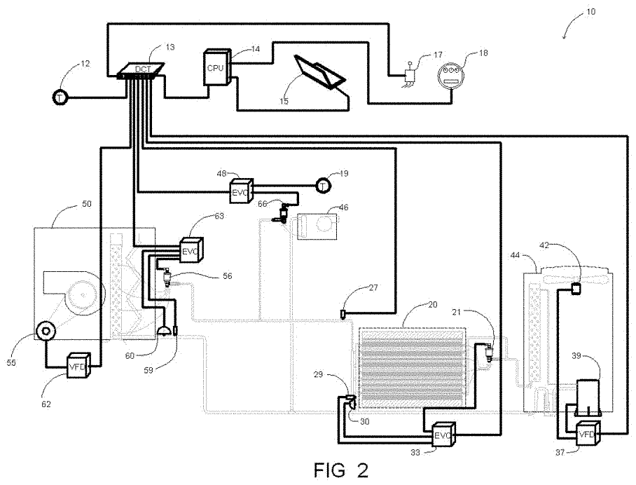

In an embodiment suction vapor is then compressed inside the Variable Frequency Compressor 39 which simultaneously raises both its pressure and temperature. This now hot vapor flows into a Hot Gas Line 40, then into an Air Cooled Condenser 41 where it is first de-superheated to its condensing temperature. Upon reaching its condensing temperature, this vapor begins to change phase to a high pressure liquid stream wherein the refrigeration process thus described hereinabove may be repeated over infinite cycles. A condenser Fan 43 pulls ambient air over the Air Cooled Condenser 41 to remove heat from high pressure hot gas, thus converting said hot gas back into a reusable high pressure liquid stream. A Condenser Fan Motor 42, the Variable Frequency Compressor 39 and their controls will be described within FIG. 2 which follows.

The method of control for the System 10 in an embodiment may now be described and understood as shown in FIG. 2. Heavy dark lines represent control interconnections between various apparatus shown comprising System 10. These lines may contain wiring in either 120 volts or 0-10 VDC, 0-5 VDC or 4-20 mA, depending upon the manufacturer's controls utilized for said functions.

While the Space Air Handling Unit 50 and the Fan Coil Unit 46 are shown as singular apparatus, in other embodiments multiples of same may exist within the System 10. Thermostatic control of the Air Handling Unit 50 may be accomplished by a Space Thermostat 12 which, in an embodiment, may be wired to a Data Collection Terminal 13. The Data Collection Terminal 13 may then be wired to a Central Processor Unit 14 which contains the software control for this system. The Central Processor Unit 14 may then be interconnected to a Computer 15. Software within the Central Processor Unit 14 simultaneously controls the Electronic Expansion Valve Controller 63 and an Air Handling Unit Variable Frequency Drive 62 to maintain space temperature. The Electronic Expansion Valve Controller 63 in turn positions the port within the Air Handling Unit Electronic Expansion Valve 56 using input from the Air Handling Unit Expansion Valve Superheat Thermistor 59 and the Air Handling Unit Expansion Valve Superheat Pressure Transmitter 60 to maintain a fixed refrigerant superheat setting within the software in the Central Processor Unit 14.

In an embodiment the Coil Unit Thermostat 19 may send its signal to an Electronic Expansion Valve Controller 48 to position the port within the Electronic Expansion Valve 66 to maintain a particular zone temperature.

In an embodiment the Module Thermistor 27 may be wired to the Data Collection Terminal 13 which in turn sends its signal to control the temperature of high pressure liquid exiting the PCCTESM 20 by controlling the port within the Module Electronic Expansion Valve 21. In an embodiment the Module Electronic Valve Controller 33 may receive signals from the Module Superheat Thermistor 29 and the Module Superheat Pressure Transmitter 30 through the Module Electronic Valve Controller 33 to maintain the superheat setting of the Module Electronic Expansion Valve 21.

In an embodiment the ACCU 44 may supply a stream of saturated high pressure liquid to the Module Electronic Expansion Valve 21 and simultaneously through a separate tubing connection, supply saturated liquid to the warm side of the PCCTESM 20 in order that saturated warm liquid may become subcooled within internal heat transfer tubing of the PCCTESM 20. In an embodiment the Module Thermistor 27 varies the speed of the Variable Frequency Compressor 39 and the Condenser Fan Motor 42 through a Condenser Variable Frequency Drive 37. This frequency drive may, in turn, be interconnected to the Data Collection Terminal 13. Software within the Central Processor Unit 14 may be programmed to simultaneously recognize the particular electric utility on-peak time period and the simultaneous state of charge of the PCCTESM 20. Said software may be written to favor highest speeds of the Variable Frequency Compressor 39 and the Condenser Fan Motor 42 during the coolest night-time ambient hours, by shifting highest electrical demand during utility on-peak hours.

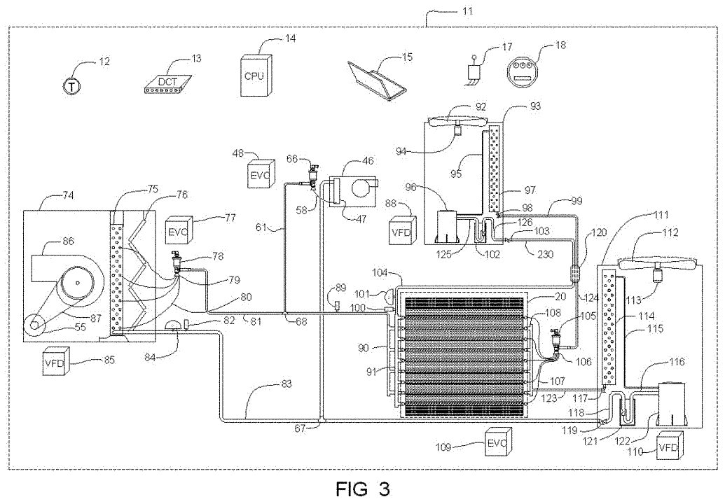

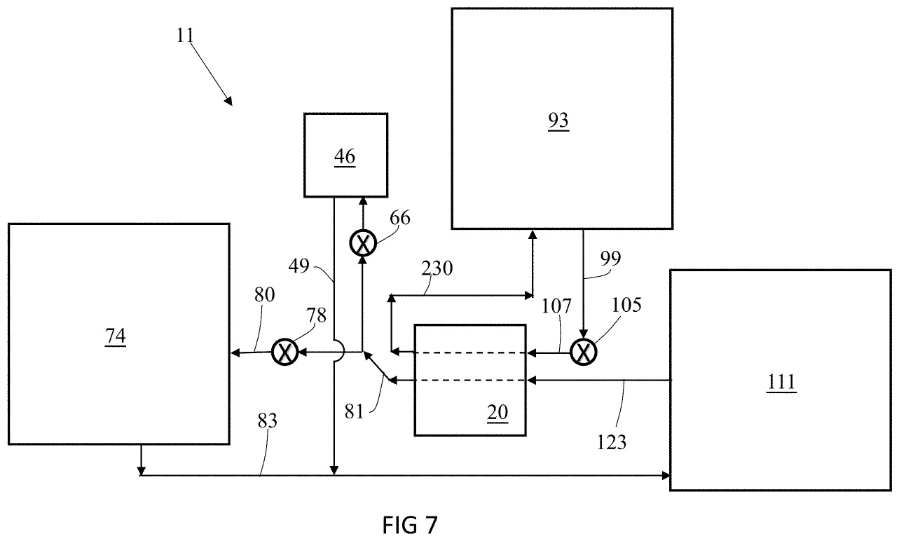

FIGS. 3 and 7 depict schematic diagrams of a second embodiment of a System 11 wherein dual condensing units are utilized. FIG. 7 is a simplified version of FIG. 3 wherein minor details have been removed to show the basic structure and interconnections of the underlying components. An ACCU 111 provides a stream of saturated high pressure liquid that first passes through the PCCTESM 20 to be subcooled, then passes to an Air Handling Unit 74 to meet building cooling loads. A Supplemental ACCU 93 may be utilized to remove heat from the PCCTESM 20. Those schooled in refrigeration technologies will recognize the advantage of this arrangement in that each ACCU 93, 111 may run at differing evaporating temperatures.

In an embodiment, a stream of saturated high pressure liquid may exit ACCU 111 after passing through a High Pressure Liquid Stop Valve 117 and into a Saturated High Pressure Liquid Line 123 which may connect to a Module Saturated High Pressure Liquid Header 108. In an embodiment, high pressure liquid then may become subcooled inside the PCCTESM 20. In an embodiment, after passing through the circuits within the PCCTESM 20, this now subcooled stream of high pressure liquid enters a Subcooled High Pressure Liquid Header 90, then enters a Subcooled High Pressure Liquid Line 81 where it may connect to a Tee 68. In an embodiment, a branch of the Tee 68 carries subcooled high pressure liquid to the Fan Coil Unit 46 after passing through the Electronic Expansion Valve 66 and into the Air Handling Unit Electronic Expansion Valve Distributor Tubing 58, then into the Fan Coil Unit Evaporator 47 to meet specific zone cooling requirements. While only a singular Fan Coil Unit 46 has been shown, in other embodiments multiples of same may exist within System 11.

In an embodiment, subcooled high pressure liquid travels down the Subcooled High Pressure Liquid Line 81 and into an Electronic Expansion Valve 78 where it then moves through a Distributor 79 and into Distributor Tubing 80 where it then may feed an Evaporator 75 inside the Air Handling Unit 74 to meet building cooling needs. While a singular Air Handling Unit 74 has been shown, in other embodiments multiples of these may exist within the System 11. The Space Thermostat 12 may control a Variable Frequency Drive 85 to set required fan speed as well as an Expansion Valve Controller 77 which controls the quantity of liquid to be fed to the Evaporator 75 in accordance within software in the Central Processor Unit 14. In an embodiment, the Variable Frequency Drive 85 controls the quantity of air to be delivered by an Air Handling Unit Fan 86 which is driven by a Belt Drive 87 and an Air Handling Unit Fan Motor 55. Air returning from the building first enters a Filter Bank 76, then passes through the Evaporator 75 in a draw-through arrangement which is typical for nearly all air handling units. The port position within the Electronic Expansion Valve 78 may be controlled by an Air Handling Unit Expansion Valve Superheat Thermistor 82 and an Air Handling Unit Expansion Valve Superheat Pressure Transmitter 84, the duality of which sense and control refrigerant vapor superheat.

In an embodiment, the now slightly superheated cold refrigerant vapor exiting the Evaporator 75 may travel into a Suction Line 83 which may connect to a Tee 67. At this juncture, slightly superheated cold refrigerant vapor from the Fan Coil Unit Evaporator 47 mixes with vapor from the Evaporator 75 and may continue down the Suction Line 83 and into a Suction Line Stop Valve 119 within the ACCU 111. In an embodiment, cold superheated refrigerant vapor may then enter a Suction Line Inlet 118 to a Suction Trap 121, then into a Compressor Suction Line 116 and finally into a Variable Speed Compressor 122. The speeds of both the Variable Speed Compressor 122 and a Condenser Fan 112 may be controlled by the Variable Frequency Drive 110.

In an embodiment, after passing through the Variable Speed Compressor 122 both pressure and temperature of refrigerant vapor has now been raised to a point where it may be condensed back into a high pressure liquid within an Air Cooled Condenser 114 after passing through a Condensing Unit Hot Gas Line 115. The purpose of the Suction Trap 121 is to catch and temporarily retain any refrigerant liquid that momentarily may exit either the Fan Coil Unit Evaporator 47 or the Evaporator 75 because liquid is incompressible inside the Variable Speed Compressor 122. Liquid also combines with refrigerant oil which dilutes it and said oil-liquid mixtures may become deleterious to bearings inside the Variable Speed Compressor 122.

Still referring to FIGS. 3 and 7, a function of the Supplemental ACCU 93 within the System 11, in an embodiment, may be to provide a stream of high pressure liquid refrigerant to a Module Electronic Expansion Valve 105 which removes latent heat from the PCCTESM 20. Refrigerant streams moved by the ACCU 111 and the Supplemental ACCU 93 do not mix one with the other and are therefore separate permitting use of a different type of refrigerant for either condensing unit if warranted by project specifics.

In an embodiment, a stream of high pressure liquid refrigerant leaves a Supplemental Air Cooled Condenser 97 through a Supplemental High Pressure Liquid Stop Valve 98 and enters a Supplemental High Pressure Liquid Line 99 which connects to a Liquid-To-Suction Heat Exchanger 120 which gives up heat to incoming cold refrigerant vapor which superheats this cold vapor. A stream of now subcooled high pressure liquid enters a Supplemental Subcooled High Pressure Liquid Line 104 which may connect to the Module Electronic Expansion Valve 105 which may be joined with a Module Electronic Expansion Valve Distributor 106 which then feeds a mixture of cold refrigerant liquid and vapor into each Module Electronic Expansion Valve Distributor Tubing 107 which then may connect to each Cold Aluminum Micro Channel Heat Exchanger Inlet Header 250, 254, 258, 262, 266 within the PCCTESM 20 shown in FIG. 5. Heat flows from each Phase Change Composite Slab 221, 222, 223, 224, 225, 226, 227, 228, 229 whenever a Supplemental Variable Speed Compressor 96 is in operation which may freeze the wax contained within each said Phase Change Composite Slab 221, 222, 223, 224, 225, 226, 227, 228, 229. This same heat flow may boil cold liquid refrigerant inside each of the Cold Aluminum Micro Channel Heat Exchangers 231, 233, 235, 237, 239 inside the PCCTESM 20 shown in FIG. 5.

In the embodiment of the System 11, similar to that of the System 10, a plurality of first heat exchangers, for example, the first through fifth cold Aluminum Micro Channel Heat Exchangers 231, 233, 235, 237, and 239 are in fluid communication with a first common inlet source and a first common outlet header. For example, in this embodiment, each of the first through fifth cold Aluminum Micro Channel Heat Exchangers 231, 233, 235, 237, and 239 is supplied by a first through fifth Cold Aluminum Micro Channel Heat Exchanger Inlet Header 250, 254, 258, 262, and 266, respectively, which are all in fluid communication with and commonly supplied by the first common inlet source comprising the Module Electronic Expansion Valve Distributor 106 via the Module Electronic Expansion Valve Distributor Tubing 107. A refrigerant vapor stream exits from each of the first through fifth cold Aluminum Micro Channel Heat Exchangers 231, 233, 235, 237, and 239 via a first through fifth Cold Aluminum Micro Channel Heat Exchanger Outlet Header 251, 255, 259, 263, and 267, respectively, which are all in fluid communication with the first common outlet header comprising a Module Suction Header 91.

Similarly, in the embodiment of the System 11, a plurality of second heat exchangers, for example, the first through fourth Warm Aluminum Micro Channel Heat Exchangers 232, 234, 236, and 238 are in fluid communication with a second common inlet source and a second common outlet header. For example, in an embodiment, a warm high pressure liquid stream enters each of the first through fourth Warm Aluminum Micro Channel Heat Exchangers 232, 234, 236, and 238 via first through fourth Warm Aluminum Micro Channel Heat Exchanger Inlet Headers 252, 256, 260, and 264, respectively, which are all in fluid communication with and commonly supplied by the second common inlet source comprising the Module Saturated High Pressure Liquid Header 108. A subcooled high pressure liquid stream exits each of the first through fourth Warm Aluminum Micro Channel Heat Exchangers 232, 234, 236, and 238 via a first through fourth Warm Aluminum Micro Channel Heat Exchanger Outlet Header 253, 257, 261, and 265, respectively, which are all in fluid communication with the second common outlet header comprising the Subcooled High Pressure Liquid Header 90.

Again looking at FIG. 5, in an embodiment a stream of cold, slightly superheated vapor leaves each of the Cold Aluminum Micro Channel Heat Exchangers 231, 233, 235, 237, 239 and enters each respective Cold Aluminum Micro Channel Heat Exchanger Outlet Header 251, 255, 259, 263 and 267. In an embodiment, this cold vapor stream enters the Module Suction Header 91, then enters the Supplemental Condensing Unit Suction Line 104. This vapor stream then enters the Liquid To Suction Heat Exchanger 120. Inside the Liquid To Suction Heat Exchanger 120 a heat transfer process takes place wherein heat is transferred from the incoming high pressure stream from the Supplemental ACCU 93 which simultaneously further superheats the incoming cold, low pressure vapor stream. In an embodiment, this now superheated low pressure vapor stream then enters a Supplemental Condensing Unit Suction Line Stop Valve 103. Superheated low pressure suction vapor then flows into a Suction Trap Entering Line 126 and enters a Supplemental Condensing Unit Suction Trap 102. Those schooled in refrigeration technology may question the need for the Supplemental Condensing Unit Suction Trap 102 if the suction vapor stream is always in a superheated state. However, the Supplemental Condensing Unit Suction Trap 102 is an additional means of compressor protection to preclude any possibility that refrigerant in a liquid state could momentarily exit any of the Cold Aluminum Micro Channel Heat Exchangers 231, 233, 235, 237, 239 within the PCCTESM 20.

Momentary liquid flood-backs can and do occur due to momentary malfunctions with the Module Electronic Expansion Valve 105. In such a circumstance, superheated low pressure suction vapor then enters a Compressor Suction Line 125 which enters the Supplemental Variable Speed Compressor 96 where both its pressure and temperature increase. This now high pressure superheated vapor stream flows into a Supplemental Condensing Unit Hot Gas Line 95 then into the Supplemental Air Cooled Condenser 97 where it first gives up its superheat then begins to condense back into a high pressure liquid state for reuse for the continuing process of vapor compression refrigeration.

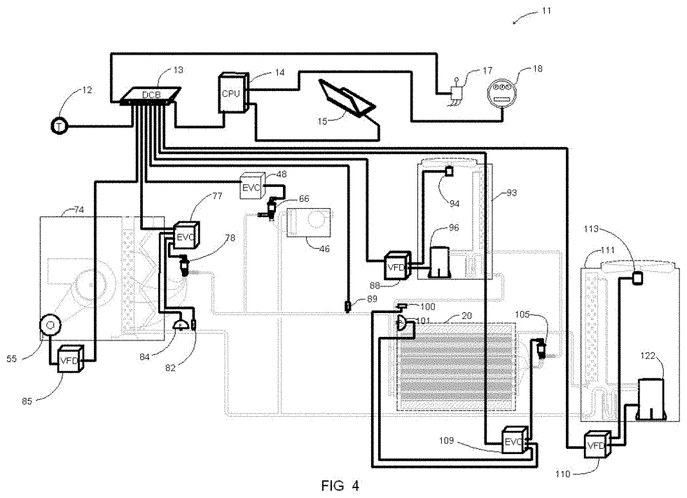

Turning now to FIG. 4, the method of control for the System 11 in an embodiment will be explained. As evidenced in examination of FIG. 4, this system differs from the System 10 in that dual condensing units are utilized. The function of Supplemental ACCU 93 may be to remove stored heat from the PCCTESM 20 whereas the function of ACCU 111 may be to meet building cooling loads. The schooled in the art will recognize that these two condensing units may run with differing suction pressures in that the freezing temperature of the PCCTESM 20 may fall in a temperature range of 4° C. to 6° C. Assuming a 6° C. temperature difference between the phase change composite freezing temperature and the saturated suction temperature of Supplemental ACCU 93, yields a −2° C. to 0° C. saturated suction temperature.

Assume that the System 11 is located in a hot dry climate, for example, such as experienced in the Desert Southwest region of the U.S., where it is not unusual for the daily high ambient dry bulb temperature to reach 48° C. with a simultaneous very dry −10° C. dew point temperature. Under these conditions, nearly all refrigeration evaporators in air conditioning duty will operate “dry” in that corresponding saturated evaporating temperatures may be as high as 9° C., well above the −10° C. dew point. This duality of saturated evaporating temperatures becomes an energy efficiency opportunity as well as electrical demand reduction during local utility peaking periods. This feature is something electrical utilities find highly desirable in their service territories.

Again looking at FIG. 4, the heavy black lines denote control interface between apparatus. In an embodiment a control interface may consist of 120 volt start-stop functions, 120 volt variable frequency that connect to variable frequency drives 85, 88, and 110, 12 volt and 4-20 mA signals. In an embodiment the Data Collection Terminal 13 receives signals from the Space Thermostat 12, the Variable Frequency Drive 85, the Expansion Valve Controller 77, a Module Thermistor 89, the Variable Frequency Drive 88, the Module Electronic Valve Controller 109, the Fan Coil Unit 46, and the Variable Frequency Drive 110. The Data Collection Terminal 13 is interconnected to the Central Processor Unit 14 which may contain the operating software for operation of the System 11. User interface takes place through the Computer 15.

During the electric utility off-peak period hours, the Supplemental Variable Speed Compressor 96 within the Supplemental ACCU 93 is enabled to run at 100% full speed until the PCCTESM 20 is fully recharged as indicated by both a Module Superheat Thermistor 100 and a Module Superheat Pressure Transmitter 101. In an embodiment the Module Thermistor 89 may override by signaling a satisfied high pressure liquid temperature setpoint which may reduce the operating speed of the Supplemental Variable Speed Compressor 96. The Variable Speed Compressor 122 within the ACCU 111 may run at whatever speed is required to maintain the setpoint temperature of the Space Thermostat 12.

During the electric utility on-peak period hours, the operating speed of the Supplemental Variable Speed Compressor 96 within the Supplemental Air Cooled Condenser 93 is reduced to 50% but may be less than 50% if the Module Thermistor 89 becomes satisfied by the temperature of cold high pressure liquid reaching its control setpoint. The operating speed of the Variable Speed Compressor 122 within the ACCU 111 may also be reduced to hold an electrical demand not greater than its control setpoint. During this same time interval, the operating speed of the Air Handling Unit Fan Motor 55 within the Air Handling Unit 74 may also be reduced in order to maintain a maximum electrical demand setpoint.

During the on-peak electrical period, suction pressures of the Supplemental Variable Speed Compressor 96 and the Variable Speed Compressor 122 may differ significantly in that the Variable Speed Compressor 122 is meeting space cooling loads whereas the Supplemental Variable Speed Compressor 96 is recharging the PCCTESM 20. As an example, the corresponding saturated suction temperature of the Supplemental Variable Speed Compressor 96 may be 0° C. whereas the saturated suction temperature of the Variable Speed Compressor 122 may be as high as 15° C. This difference in suction pressures is an energy saving technique as well as a demand shifting technique.

### INDUSTRIAL APPLICABILITY

A cooling system is presented in two configurations. A first configuration utilizes a single ACCU to provide cooling to a space while simultaneously removing heat from a PCCTESM. A second configuration utilizes dual ACCUs including a first ACCU to provide cooling to a space and a second ACCU to remove heat from the PCCTESM. The system and all of its components are manufacturable by industry.

We claim:

1. A cooling system, comprising:
an air cooled condensing unit (ACCU) having a condenser outlet and a condenser inlet;
a phase change composite thermal energy storage module (PCCTESM) having first and second fluid paths disposed therethrough, each of the first and second fluid paths having an inlet and an outlet;
at least one air handling unit (AHU) having an AHU inlet and an AHU outlet;
a first expansion valve disposed between the condenser outlet and the first fluid path inlet;
a fluid connection between the second fluid path inlet and the condenser outlet;
a second expansion valve disposed between the AHU inlet and the second fluid path outlet; and
a second fluid connection that connects the first fluid path outlet and the AHU outlet to the condenser inlet.

2. The cooling system of claim 1, wherein the at least one AHU comprises two or more AHU's each having an AHU inlet and an AHU outlet, wherein the second expansion valve is disposed between each AHU inlet and the second fluid path outlet, and the second fluid connection connects the first fluid path outlet and each AHU outlet to the condenser inlet.

3. The cooling system of claim 1, wherein the PCCTESM comprises at least one phase change composite slab (PCCS) disposed in thermal contact with the first and second fluid paths.

4. The cooling system of claim 3, wherein the PCCTESM comprises a plurality of PCCS's each disposed in thermal contact with the first and second fluid paths.

5. The cooling system of claim 4, wherein the first fluid path comprises a plurality of first heat exchangers and the second fluid path comprises a plurality of second heat exchangers.

6. The cooling system of claim 5, wherein the plurality of first heat exchangers are in fluid communication with a first common inlet source and a first common outlet header, and the plurality of second heat exchangers are in fluid communication with a second common inlet source and a second common outlet header.

7. The cooling system of claim 6, wherein each of the pluralities of first and second heat exchangers comprises an aluminum micro channel heat exchanger.

8. A cooling system, comprising:
a first air cooled condensing unit (ACCU) having a first condenser outlet and a first condenser inlet;
a second air cooled condensing unit (ACCU) having a second condenser outlet and a second condenser inlet;
a phase change composite thermal energy storage module (PCCTESM) having first and second fluid paths disposed therethrough, each of the first and second fluid paths having an inlet and an outlet;
at least one air handling unit (AHU) having an AHU inlet and an AHU outlet;
a first fluid connection between the first condenser outlet and the second fluid path inlet;
a first expansion valve disposed between the AHU inlet and the second fluid path outlet;
a second expansion valve disposed between the second condenser outlet and the first fluid path inlet;
a second fluid connection between the first fluid path outlet and the second condenser inlet; and
a third fluid connection that connects the AHU outlet to the first condenser inlet.

9. The cooling system of claim 8, further comprising at least one refrigerant.

10. The cooling system of claim 9, wherein the at least one refrigerant comprises first and second refrigerants, and wherein the first refrigerant flows through the first ACCU and the second refrigerant flows through the second ACCU.

11. The cooling system of claim 8, wherein the PCCTESM comprises at least one phase change composite slab (PCCS) disposed in thermal contact with the first and second fluid paths.

12. The cooling system of claim 11, wherein the PCCTESM comprises a plurality of PCCS's each disposed in thermal contact with the first and second fluid paths.

13. The cooling system of claim 12, wherein the first fluid path comprises a plurality of first heat exchangers and the second fluid path comprises a plurality of second heat exchangers.

14. A phase change composite thermal energy storage module (PCCTESM), comprising:
a first fluid path disposed therethrough, the first fluid path having an inlet and an outlet;
a second fluid path disposed therethrough, the second fluid path having an inlet and an outlet; and
at least one phase change composite slab (PCCS) disposed in thermal contact with the first and second fluid paths.

15. The PCCTESM of claim 14, wherein the at least one PCCS comprises a thermally conductive graphite matrix with a wax impregnated within the graphite matrix.

16. The PCCTESM of claim 15, wherein the wax has a liquid to solid phase change temperature in a range between about 2° C. and about 4° C.

17. The PCCTESM of claim 14, wherein the at least one PCCS comprises a plurality of PCCS's each disposed in thermal contact with the first and second fluid paths.

18. The PCCTESM of claim 17, wherein the first fluid path comprises a plurality of first heat exchangers and the second fluid path comprises a plurality of second heat exchangers.

19. The PCCTESM of claim 18, wherein the plurality of first heat exchangers are in fluid communication with a first common inlet source and a first common outlet header, and the plurality of second heat exchangers are in fluid communication with a second common inlet source and a second common outlet header.

20. The PCCTESM of claim 19, wherein the plurality of PCCS's and the pluralities of first and second heat exchangers are arranged in a layered structure that is configured so that each PCCS has a first heat exchanger in thermal contact with a first side of the PCCS and a second heat exchanger in thermal contact with a second opposite side of the PCCS.
